(19) United States
(12) Patent Application Publication
(10) Pub. No.: US 2013/0067730 A1
(43) Pub. Date: Mar. 21, 2013

(54) Container Label

(71) Applicant: Leigh Mattson, Sugar Land, TX (US)

(72) Inventor: Leigh Mattson, Sugar Land, TX (US)

(21) Appl. No.: 13/235,867

(22) Filed: Sep. 19, 2011

(51) Int. Cl. B23P 19/00

(52) U.S. Cl. 29/700

(57) ABSTRACT

A system and method for placing a label on a container is described herein. Specifically, a system for labeling a container can comprise a closed-form band having an inner surface, an outer surface, a height, and a circumference capable of circumscribing a container, and a sign affixed to said outer surface of said band.

### BACKGROUND

This disclosure relates to a system and method for placing a label on a container.

Often, containers or tables can be used to separate items. For example, garbage containers can be used for plastics, papers, metals, or non-recyclable items. Often, When garbage cans are placed in a public locations or large social gatherings, it is not always clear which garbage containers are to be used for which items. Similarly, a cooler can hold soft drinks, beers, water, or food. Often, a person approaching a bank of coolers has to open each until he or she finds the item of choice. While some solutions have been presented, most are inadequate or not aesthetically pleasing. For example, some have used basic color-coding, but with no color system widely known throughout the population, such method is ineffective. In another solution, people have written directly on the containers, however such solutions often look bad, and further make repurposing the container difficult.

As such it would be advantageous to have an improved system and method for placing a label on a container.

### SUMMARY

A system and method for placing a label on a container is described herein.

In one embodiment, a system for labeling a container can comprise a closed-form band having an inner surface, an outer surface, a height, and a circumference capable of circumscribing a container, and a sign affixed to said outer surface of said band.

Additionally, in another embodiment, a system for labeling a container can comprise an open-form band having an inner surface and an outer surface, a height, and a length capable of circumscribing a container, further wherein said length has a first end and a second end. The system for labeling a container further comprise a first fastener connected to said first end, a second fastener connected to said second end, wherein said second fastener is capable of connecting with said first fastener, and a sign affixed to said outer surface of said band.

Finally, in one embodiment, a system for labeling a container can comprise a band having an inner surface and an outer surface, a height, and length capable of circumscribing a container, a sign holder affixed to said outer surface of said band.

### BRIEF DESCRIPTION OF THE DRAWINGS

FIG. 1 illustrates a band placed on a container.

FIG. 2 illustrates another embodiment of band placed on a garbage container.

FIG. 3 illustrates another embodiment of band wherein band is a continuous closed-loop of material.

FIG. 4 illustrates another embodiment of band wherein cover is an open-loop of material comprising a first end, a second end, and one or more fasteners.

FIG. 5 illustrates a zoom in of another embodiment of band wherein cover further comprises a sign holder.

FIG. 6 illustrates a cooler comprising a band with an exterior pocket.

FIG. 7 illustrates another embodiment of band comprising secret pockets.

### DETAILED DESCRIPTION

Described herein is a system and method for placing a label on a container. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

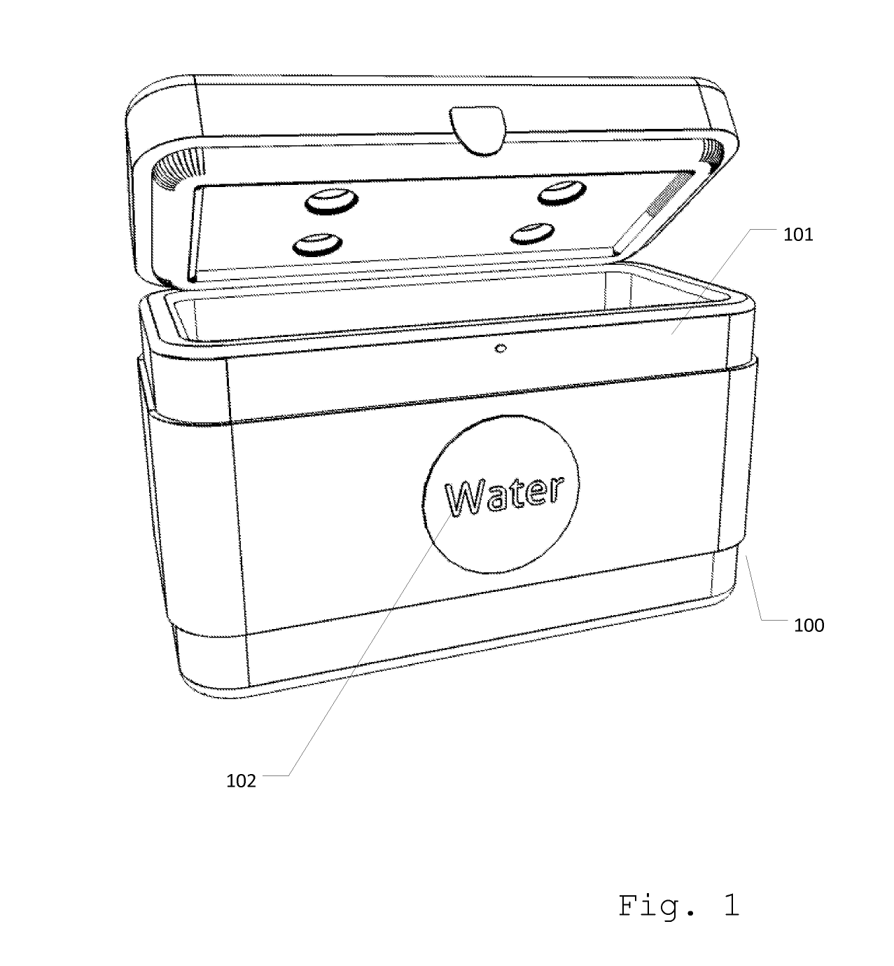

FIG. 1 illustrates a band 100 placed on a container 101. Band 100 can be a piece of material wrapping around the edges, and sides of container 101. Band 100 can comprise, but is not limited to, cloth, natural rubber, and/or plastic. If constructed of stretchable materials, band 100 can be stretched around container 101. In this manner, band 100 can grip container 101. The height of band 100 can range to cover most or all of container 101 sides, or can be only a portion of the height of container 101. In embodiments where container is covered, band 100 can provide insulation. Furthermore, decorative textures can be placed on band 100. Band 100 can further comprise a sign 102. For the purpose of this disclosure, sign 102 can be constructed of materials that include, but are not limited to, cloth, plastic, a white board, or a chalkboard. Sign 102 can be circular, oval, square, rectangular, or any other shape. In one embodiment, sign 102 can be a separate entity from band 100, and connected to band 100 during fabrication. For example, sign 102 can be sewn to band 100. In another embodiment, sign 102 can attach using connectors such as hook and loop fasteners, or buttons. In such embodiment, container can be repurposed by changing sign 102 with a different sign 102. In another embodiment, sign 102 can be a combined portion of band 100. For example, sign 102 can be printed directly to band, or glued on as an overlay.

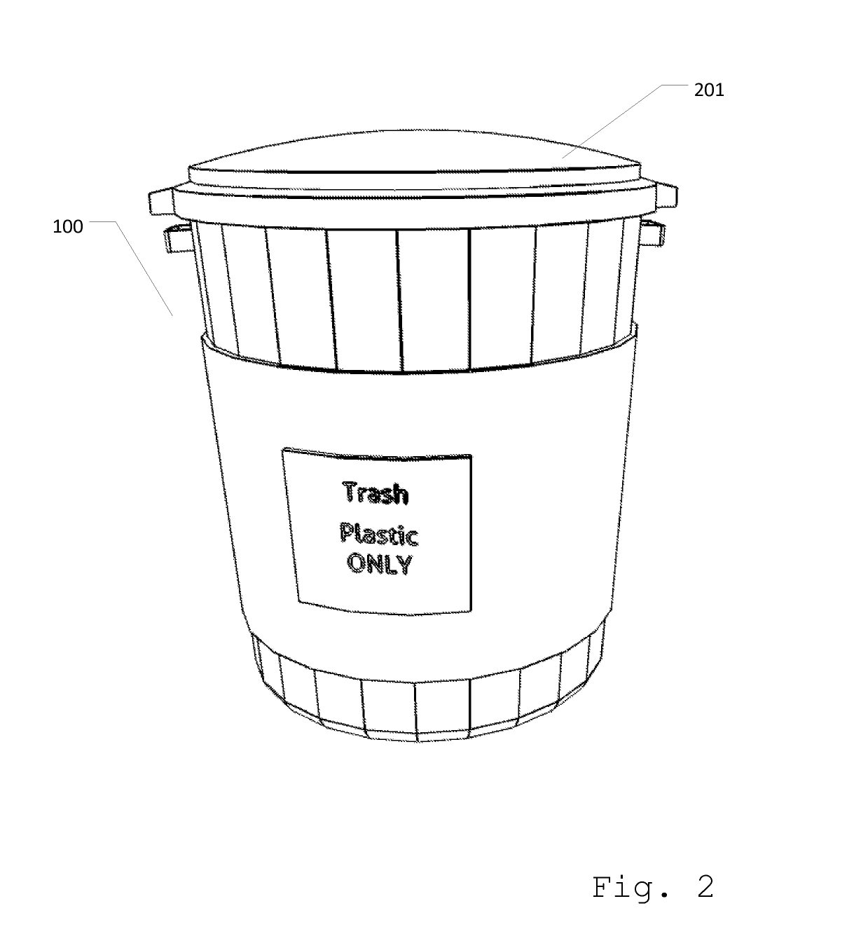

FIG. 2 illustrates another embodiment of band 100 placed on a garbage container 201. In such embodiment, band 100 can be manufactured to be the substantially similar dimensions as particular garbage container 201. For example, some garbage containers taper from top to bottom, as shown in FIG. 2. To accommodate, band 100 can decrease in radius from top to bottom.

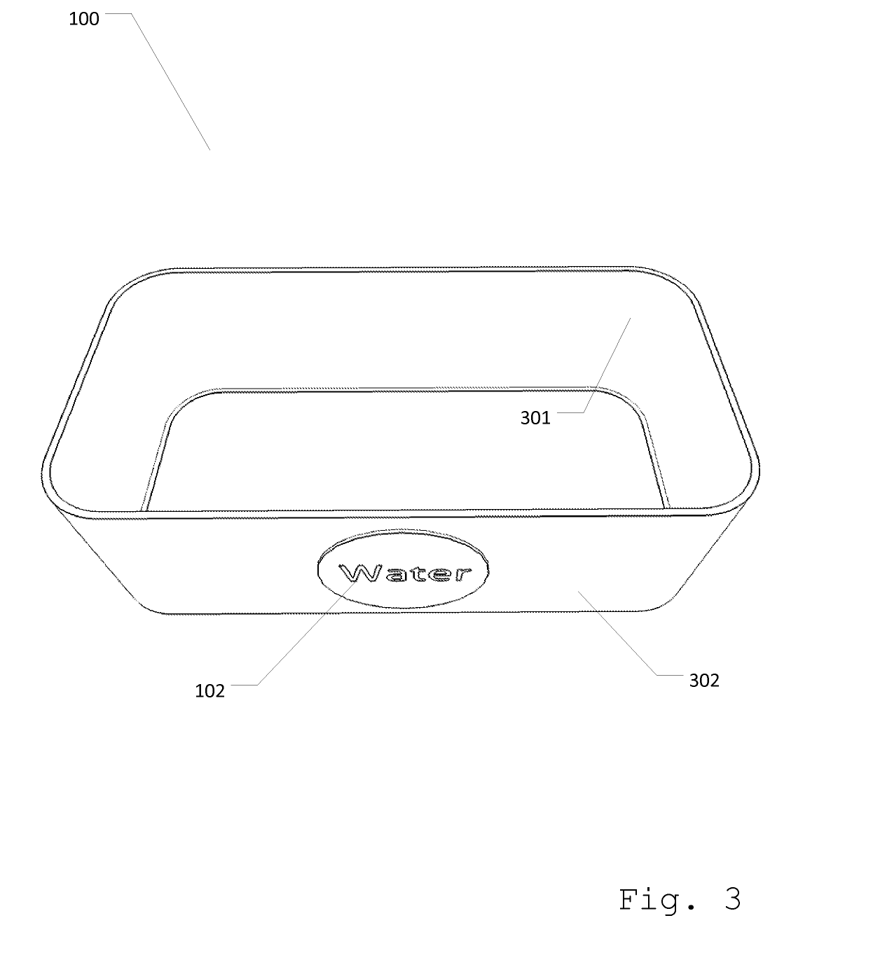

FIG. 3 illustrates another embodiment of band 100 wherein band 100 is a continuous closed loop of material. In such embodiment, band 100 can comprise of materials such as elastic, fabric, rubber, or neoprene. Further in such embodiment, band 100 can comprise of an inner surface 301 and an outer surface 302. Inner surface 301 is the innermost side of band 100 which makes contact to a container. Outer surface 302 is the outer side of band 100 where sign 102 can be attached.

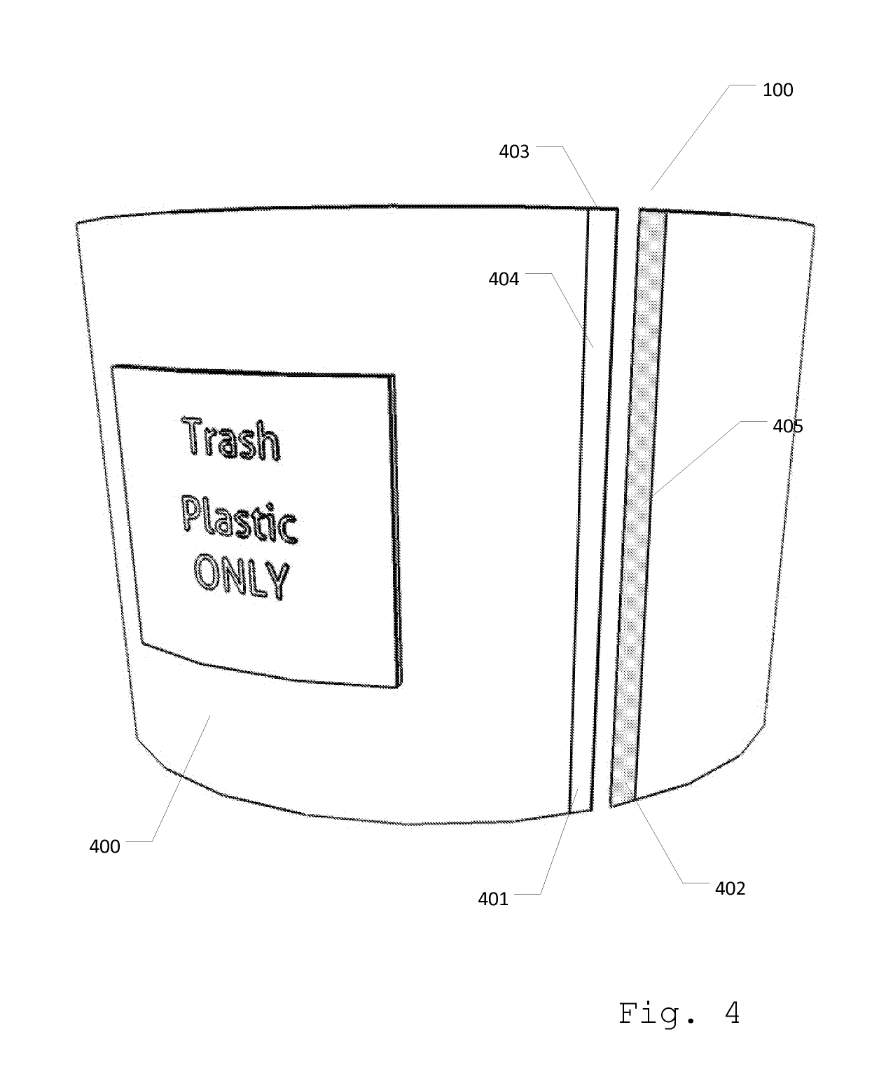

FIG. 4 illustrates another embodiment of band 100 wherein cover 400 is an open-looped material comprising a first end 401, a second end 402, and one or more fasteners 403. When band 100 is wrapped around a container, first end 401 and second end 402 can be attached using fasteners 403. For the purpose of such disclosure, fastener 403 can be, but is not limited to, a clasp, a hook-and-loop fastener, one or more buttons, and/or a string or set of strings. For example, a first string can be connected to a first end 401, and a second string can be connected to a second end 402. First string and second string can be tied together. In another example wherein fastener 403 is hook-and-look fastener, first end 401 can comprise of a hook 404 and second end 402 can comprise of a loop 405 as shown in FIG. 4.

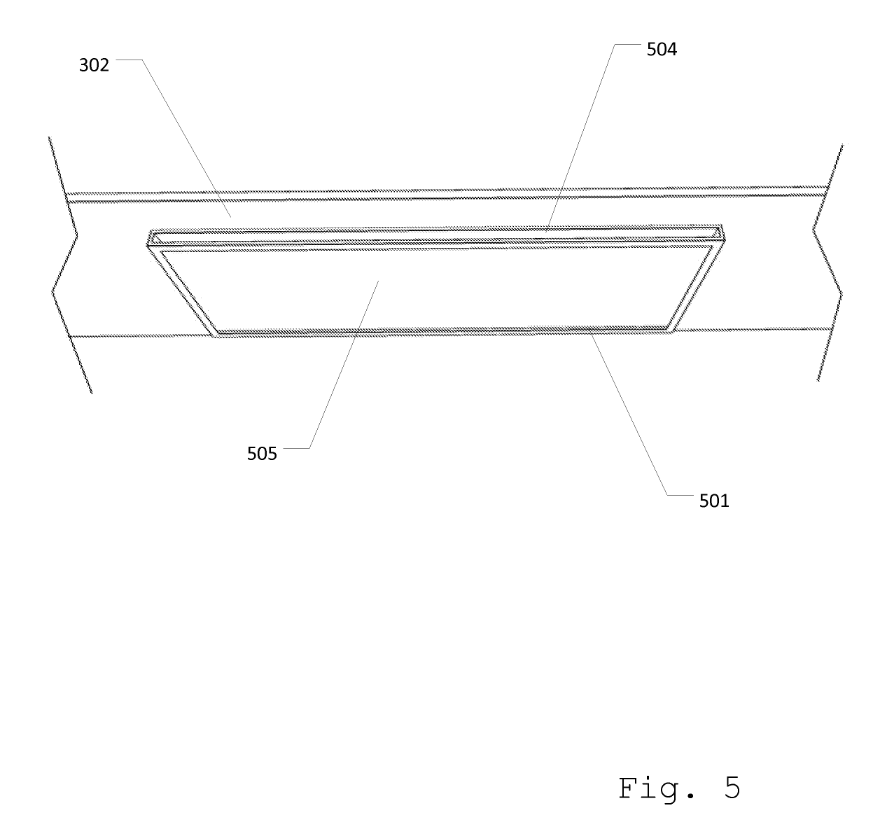

FIG. 5 illustrates a zoom in of another embodiment wherein band 100 further comprises sign holder 501. For the purpose of this disclosure, a sign holder 501 can be, but is not limited to, plastic, metal, wood, and/or neoprene. Sign holder 501 can be placed on outer surface 302 of band 100 using fasteners. In one embodiment, sign holder 501 is a built-in component of band 100. Sign holder 501 can comprise an aperture 504. Aperture 504 can be on the top, left, and/or right side of sign holder 501. Aperture 504 can be wide enough allowing the insertion of a paper or other sign 505.

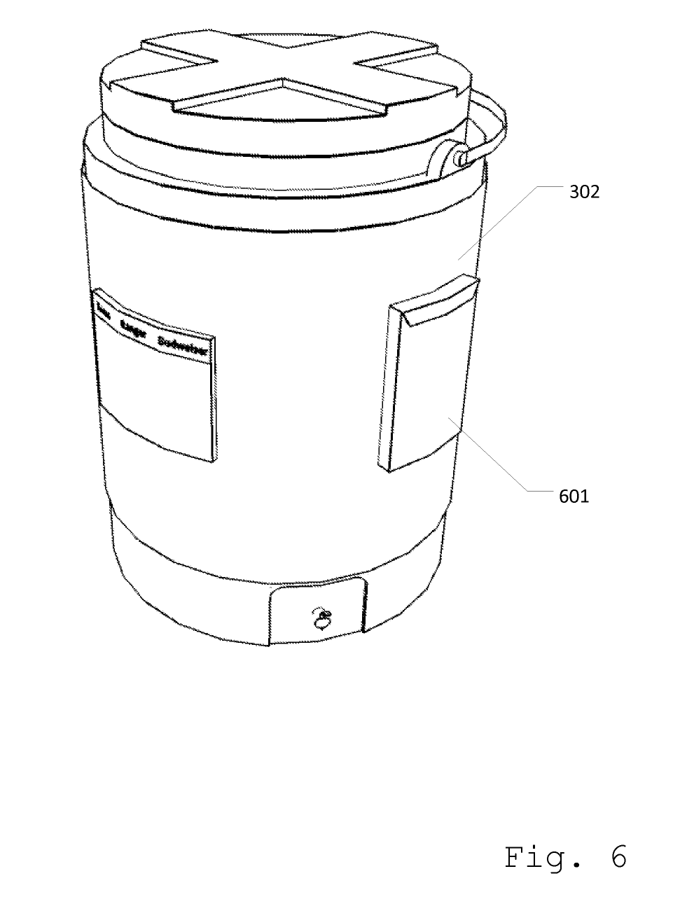

FIG. 6 illustrates a cooler comprising band 100 with an exterior pocket 601. In one embodiment, exterior pocket 601 can be an incorporated element of band 100, using band 100 as one of the walls. In another embodiment, exterior pocket 601 can be a separate element placed on the outer surface 302 of band 100. Exterior pocket 601 can include materials such as, but not limited to, leather, cloth, and/or plastic. In one embodiment wherein exterior pocket 601 is a separate element, exterior pocket 601 can be attached to band 100 using a sealing adhesive, or can be sewn, and/or glued on band 100. In another embodiment wherein exterior pocket 601 is an incorporated element, exterior pocket 601 can be an extrusion from band 100. Exterior pocket 601 can provide storage for miscellaneous items such as plates, napkins, condiments, and/or any utensils, or eyeglasses. In another embodiment, several exterior pockets 601 can be attached to band 100 providing further storage.

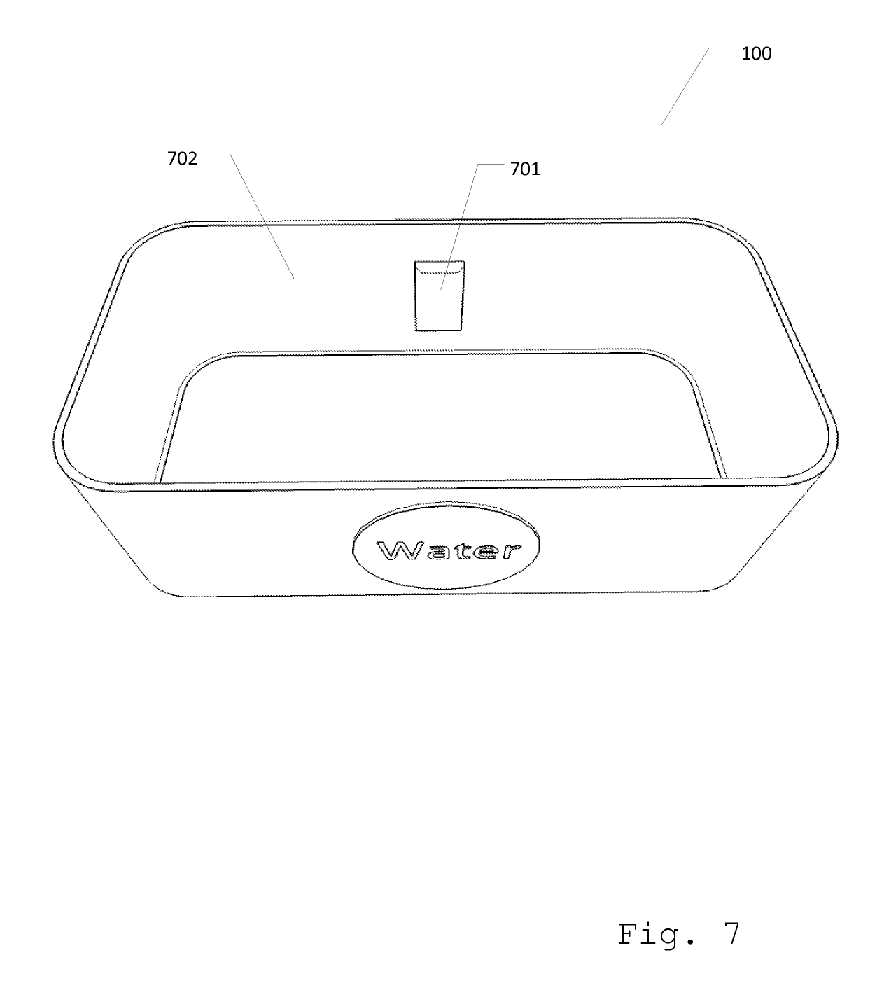

FIG. 7 illustrates another embodiment of band 100 comprising a secret pocket 701. Secret pocket 701 can be attached to the innermost side portion 702 of band 100, as shown in FIG. 7. However, secret pocket 701 can be on any portion of innermost side 702 of band 100. Secret pocket 701 can be either a built-in feature of band 100, or can be a separate feature affixed to the innermost side portion 702 of band 100. Secret pocket 701 can allow the storage of important belongings such as keys, a mobile phone, and/or a wallet.

Various changes in the details of the illustrated embodiments are possible without departing from the scope of the following claims. Some embodiments may combine the components described herein. Similarly, one or more of the described components may be omitted, depending upon the specific operational environment the system is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for labeling a container comprising
a closed-form band having an inner surface, an outer surface, a height, and a circumference capable of circumscribing a container; and
a sign affixed to said outer surface of said band.

2. The system of claim 1 wherein said height of said closed-form band is similar to a height of said container.

3. The system of claim 1 wherein said closed-form band is stretched to the size of said container.

4. The system of claim 1 wherein said inner surface makes contact to said container.

5. The system of claim 1 wherein said sign is sewed to said outer surface of said band.

6. The system of claim 1 wherein said sign is glued to said outer surface of said band.

7. The system of claim 1 wherein said sign is printed on said outer surface of said band.

8. A system for labeling a container comprising
an open-form band having an inner surface and an outer surface, a height, and a length capable of circumscribing a container, further wherein said length has a first end and a second end,
a first fastener connected to said first end;
a second fastener connected to said second end, wherein said second fastener is capable of connecting with said first fastener; and
a sign affixed to said outer surface of said band.

9. The system of claim 8 wherein said fastener is hook-and-loop.

10. The system of claim 8 wherein said fastener is a set of strings comprising of a first string and a second string.

11. The system of claim 10 wherein said first string is attached to said first end of said length of said open-form band.

12. The system of claim 10 wherein said second string is attached to said second end of said length of said open-form band.

13. The system of claim 8 wherein said fastener is buttons.

14. A system for labeling a container comprising
a band having an inner surface and an outer surface, a height, and length capable of circumscribing a container; and
a sign holder affixed to said outer surface of said band.

15. The system of claim 14 wherein said band is closed-loop.

16. The system of claim 14 wherein said band is open-loop.

17. The system of claim 14 wherein said sign holder is a built-in component of said band.

18. The system of claim 14 wherein said sign holder is a separate component of said band.

19. The system of claim 18 wherein said sign holder comprises an aperture wherein said aperture allows the insertion of a paper.

20. The system of claim 19 wherein said aperture further allows the insertion of other sign.
